(19) United States
(12) Patent Application Publication
(10) Pub. No.: US 2001/0053982 A1
(43) Pub. Date: Dec. 20, 2001

(54) Method of selling measuring or analyzing apparatus

(75) Inventor: Naoaki Niwa, Sagamihara-shi (JP)

Correspondence Address: KANESAKA AND TAKEUCHI, 1423 Powhatan Street, Alexandria, VA, 22314, US

(73) Assignee: SHIMADZU CORPORATION

(21) Appl. No.: 09/854,505

(22) Filed: May 15, 2001

(30) Foreign Application Priority Data
May 24, 2000 (JP) 2000-153157

(51) Int. Cl. G06F 17/60

(52) U.S. Cl. 705/1; 705/52; 705/63

(57) ABSTRACT

In order to charge a fee according to a using condition of a treating apparatus, i.e. measuring or analyzing apparatus, the treating apparatus is connected to a terminal on a user's side and a server on a seller's side through an internet. The cost of the measuring or analyzing apparatus is charged according to the using condition through the internet, i.e. based on a measured rate system. The measuring or analyzing apparatus is transferred to the side of the user, but the user can start using the apparatus with a small sum of money.

### BACKGROUND OF THE INVENTION AND RELATED ART STATEMENT

The invention relates to a method and a system of conducting a business with a treating apparatus, and more particularly to a sales method and a sales system for delivering the treating apparatus, i.e. measuring or analyzing apparatus, to a user before complete payment is made.

In case a measuring or analyzing apparatus is offered to a user, heretofore, the measuring or analyzing apparatus has been sold based on a lump sum sale (one time payment), leasing sale, or rental system. FIGS. 5(a) and 5(b) are block diagrams for explaining the measuring or analyzing apparatus based on the lump sum sale or the leasing sale.

Expenses required for selling the measuring or analyzing apparatus include a manufacturing cost for manufacturing the measuring or analyzing apparatus, a business profit, a guaranty cost and the like. Incidentally, the manufacturing cost includes an apparatus manufacturing cost required for manufacturing the measuring or analyzing apparatus itself, a development cost, an interest charge and the like.

In the lump sum sale, as shown in FIG. 5(a), the whole expense required for the sale of the measuring or analyzing apparatus is charged altogether at a time of the sale. Also, in the leasing sale, as shown in FIG. 5(b), the measuring or analyzing apparatus is sold to a leasing company at the same price as that sold based on the lump sum sale, and the leasing company adds an interest cost to the amount from the manufacturer and charges to the user. Further, in the rental system, the apparatus is rented according to a request from a user, and a rental company charges its rent.

In the conventional sales methods, there has been a problem in the purchase price of the measuring or analyzing apparatus for the user. Also, for the seller, there has been a problem in physical movement of the apparatus in case of the rental system.

In the lump sum sale, the user has to pay at once all the expenses required for the sale of the measuring or analyzing apparatus, which are determined by the seller's situations regardless of a short or long time operation of the apparatus and the number of modes to be applied among a plurality of measuring or analyzing modes. Therefore, when the operation time of the apparatus is short and the number of the measuring or analyzing modes is small, the lump sum sale results in a comparatively high cost.

In the leasing sale, the user basically has the same problem as that of the lump sum sale. Further, the user has to pay an extra interest to the leasing company.

Also, in the sale by the rental system, it is impossible to stably sell the apparatus since needs of the measurement and analysis which are required by the user are not known to the manufacturer. Also, whenever the measuring or analyzing apparatus is rented, the apparatus has to be transferred, which results in a great expense, especially, for a large apparatus, and is impractical in view of the facilities required for its installation place and adjustment of the apparatus required after its movement.

In view of the above problems, an object of the present invention is to provide a method and system for conducting a business with a treating apparatus, i.e. sales method and a sales system of a measuring or analyzing apparatus, wherein the measuring or analyzing apparatus is delivered to the user before the complete payment is made, and the user can start using the measuring or analyzing apparatus with a small amount of payment with respect to the whole expense.

Further objects and advantages of the invention will be apparent from the following description of the invention.

### SUMMARY OF THE INVENTION

The present invention relates to a method and system of conducting a business with a treating apparatus, i.e. measuring or analyzing apparatus. In particular, it relates to a sales method for charging an amount of money corresponding to a using condition of the measuring or analyzing apparatus installed in a user's site, wherein the user can use the measuring or analyzing apparatus with a small amount of money with respect to the total amount of the money required for a normal sale.

In order to charge the amount of money corresponding to the using conditions of the measuring or analyzing apparatus, the sales method of the measuring or analyzing apparatus according to the present invention comprises connecting the measuring or analyzing apparatus to a server on the side of a seller through a terminal on a side of the user and an internet (communication line), so that all or a part of expenses of the measuring or analyzing apparatus is charged through the internet according to the using conditions, i.e. based on a measured rate system.

Also, a sales system for selling the measuring or analyzing apparatus to the user is structured such that the terminal on the user's side is provided with connecting means for connecting the measuring or analyzing apparatus to the internet; and the server on the seller's side is provided with accounting means for calculating expenses according to the using conditions of the measuring or analyzing apparatus. The accounting means calculates an amount to be charged, of the measuring or analyzing apparatus based on process contents and operation time of the measuring or analyzing apparatus obtained through the internet to thereby charge the amount of fee according to the using conditions of the measuring or analyzing apparatus.

The amount of the fee to be charged according to the using conditions of the measuring or analyzing apparatus can be calculated such that a standard amount of all the expenses or a part thereof required for selling the measuring or analyzing apparatus is calculated in advance with reference to the mode number for analysis of the measurement or analysis, process contents and/or an estimated using cumulative time; and the standard amount is multiplied by the kind of the user, the mode number of the measurement or analysis to be used, process contents and operation time, to obtain the amount of fee to be charged. The mode number of the measurement or analysis, process contents and operation time can be obtained from the measuring or analyzing apparatus connected through the internet.

Also, expenses required for manufacturing the measuring or analyzing apparatus may be charged at once as an initial fixed cost, and the remaining expenses may be charged based on the measured rate system.

Thus, the user may only make a payment based on the measured rate system according to the operation time of the measuring or analyzing apparatus, used mode number, process contents and the like, so that there is no necessity of paying all the expenses regardless of the operation time, the number of the modes to be used among a number of measuring and analyzing modes, or difficulty of the process contents, as in the conventional sales method.

Also, according to the present invention, since the using conditions, such as the operation time of the apparatus, using modes and process contents, can be obtained through the internet at a real time, data about the marketing can also be collected.

Also, an addition or upgrade of the measuring and analyzing programs can be made, and a fault diagnosis of the apparatus can also be carried out through the internet.

According to the present invention, when a new software is purchased, if demonstration and trial softwares are retained in the server, business activities can be performed to thereby reduce a sales cost.

According to the present invention, even when the sale of the apparatus is decreased, the seller can obtain a stable profit through the use of the user.

### BRIEF DESCRIPTION OF THE DRAWINGS

FIG. 1 is a schematic diagram for explaining a sales method and a sales system according to the present invention;

FIG. 2 is a schematic diagram of the sales method and the sales system according to the present invention;

FIG. 3 is a chart for explaining tasks between a terminal on a side of a user and a server on a side of a seller in the sales method and the sales system according to the present invention;

FIG. 4 is a flow chart for explaining an example of a process of the server in the sales method and the sales system according to the present invention;

FIG. 5(a) is a block diagram for explaining the measuring or analyzing apparatus through a lump sum sale; and

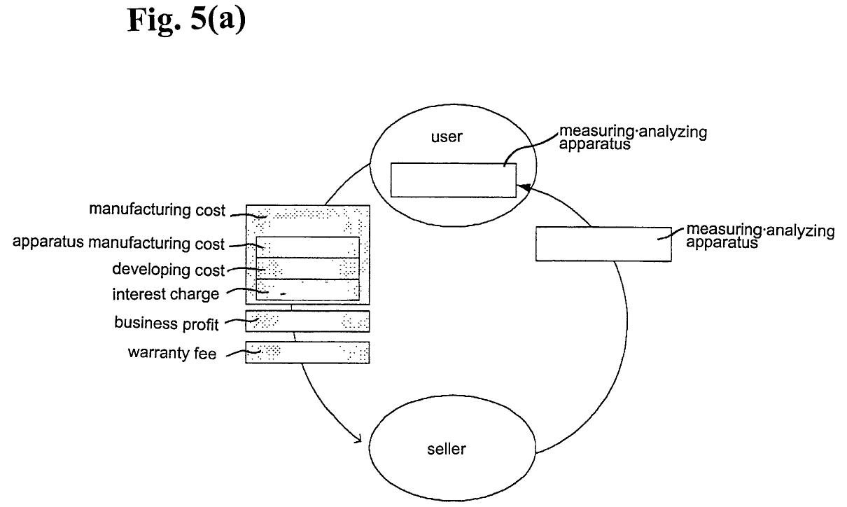

FIG. 5(b) is a block diagram for explaining the measuring or analyzing apparatus through a leasing sale.

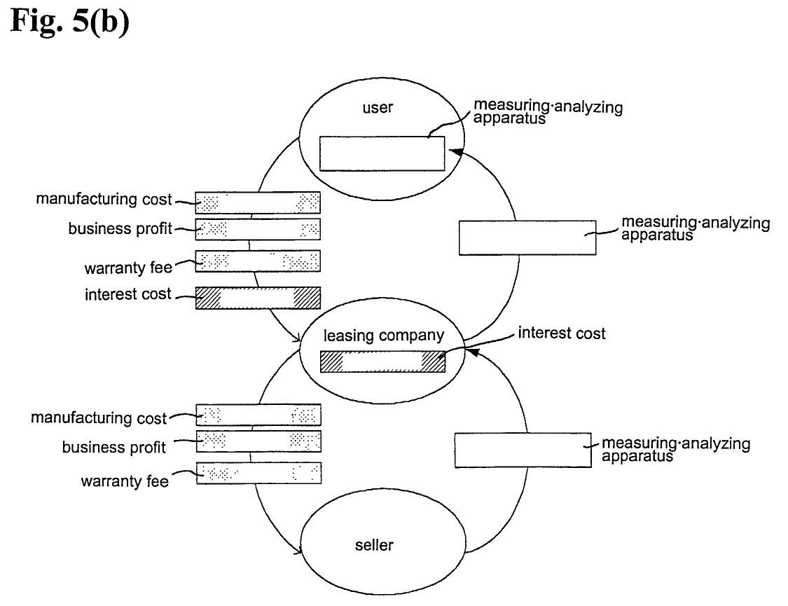

### DETAILED DESCRIPTION OF PREFERRED EMBODIMENTS

Hereunder, embodiments according to the present invention are explained with reference to the accompanying drawings. Embodiments of a sales method and a sales system of a measuring or analyzing apparatus according to the present invention are explained with reference to the drawings.

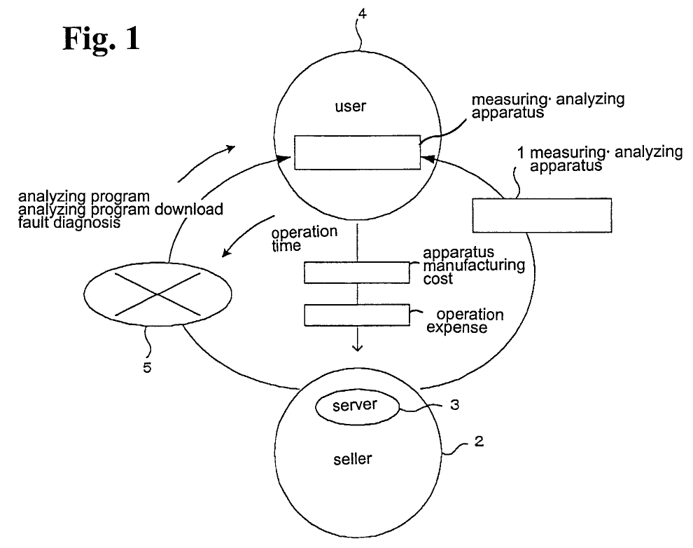

FIG. 1 is a block diagram for explaining the sales method and the sales system according to the present invention. A seller 2 furnishes a user 4 with a measuring or analyzing apparatus 1, and the user 4 connects the measuring or analyzing apparatus 1 to a server 3 on a side of the seller 2 through an internet 5. When the measuring or analyzing apparatus 1 is purchased, the user 4 pays the manufacturing cost of the apparatus as an initial cost, and after introduction of the apparatus, pays operation expenses according to the using conditions of the apparatus. A fee for the operation expenses can be charged by the server 3 through obtaining data of the using conditions of the measuring or analyzing apparatus 1 on the side of the user 4 through the internet 5. Also, the user 4 can download a program to be used for measurement or analysis from the server 3 through the internet 5 to thereby add usable measuring or analyzing modes or upgrade. In addition thereto, the user can receive services for fault-diagnosing the apparatus 1 from the server 3.

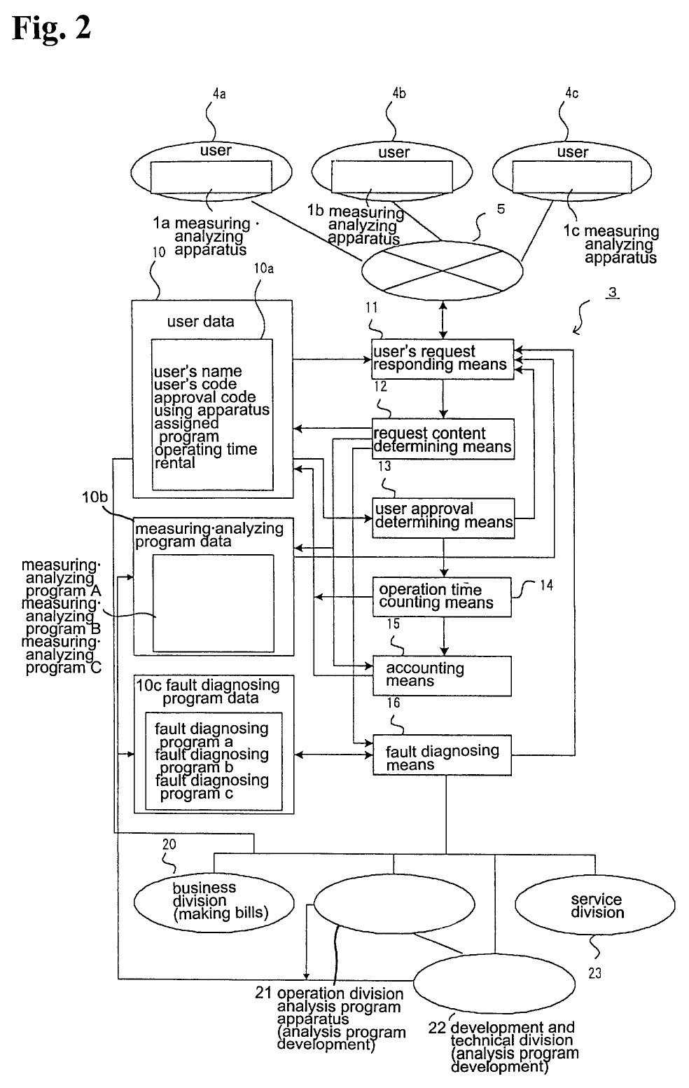

FIG. 2 shows a schematic diagram of the sales method and the sales system in detail. In FIG. 2, the server 3 on the side of the seller is connected to terminals of a plurality of users 4a, 4b, 4c, . . . through an internet 5; the respective terminals are connected to the measuring or analyzing apparatuses 1a, 1b, 1c, . . . purchased by the respective users; and the server 3 can obtain the using conditions of the respective measuring or analyzing apparatuses through the internet 5.

The server 3 includes user's request responding means 11 for responding to a request from each user; request content determining means 12 for determining contents of the request from the user; use approval determining means 13 for approving use of a measuring or analyzing program with respect to the measuring or analyzing apparatus held by the user; operation time counting means 14 for counting an operation time of the measuring or analyzing apparatus 1 held by the user; accounting means 15 for calculating an amount of fee according to the counted operation time; fault diagnosing means 16 for remote-diagnosing a fault of the measuring or analyzing apparatus held by the user; and a data base 10 for housing various data, such as user's data 10a for housing data relating to the users, measuring and analyzing program data 10b for housing the measuring and analyzing programs to be used by the measuring or analyzing apparatus; and fault diagnosing program data 10c for performing a fault diagnosis.

The user's data 10a include various data, such as user's names and user's codes for identifying the users 4; use apparatus codes for identifying the measuring or analyzing apparatuses 1 installed in the users 4; assigned or setting programs for identifying the programs approved to be used by the users 4 under agreements among the measuring or analyzing programs to be applicable to the measuring or analyzing apparatuses 1 installed in the respective users 4; approval codes for approving use of the measuring or analyzing apparatuses 1 and use of the assigned programs with respect to the respective users 4; operation times of the measuring or analyzing apparatuses 1 installed in the users 4; and fees of the users 4.

The measuring or analyzing program data 10b house a measuring or analyzing program A, measuring or analyzing program B and measuring or analyzing program C, which are developed and upgraded at an operation division or a development & technical division, and applied to the measuring or analyzing apparatus. When the user 4 requests or the upgrade is made, these programs are transmitted from the user's request responding means 11 to the user 4.

The fault diagnosing program data 10c house programs and data for inspection to carry out a fault diagnosis of the measuring or analyzing apparatus, which are developed and upgraded at the operation division or the development & technical division.

The user's request responding means 11 is connected to the users 4 through the internet 5 to receive requests from the users 4, and at the same time, perform response processes for sending various data to the users 4. At this time, the user's request responding means 11 reads the user's name, user's code and the like from the user's data 10a to identify the user.

The request content determining means 12 determines contents of various requests for, such as, use of the measuring or analyzing apparatuses and programs held by the users, addition of programs or upgrade, a fault diagnosis and using conditions and accounting conditions, and sends command to the respect process means to process the various requests.

The use approval determining means 13 refers the measuring or analyzing apparatus and program requested by the user 4 to the use apparatus code and program name assigned in the user's data 10a to determine whether the use thereof is approved or not for the user 4, and in case the use is approved, an approval code is transmitted to the user from the user's request responding means 11 through the internet 5.

The operation time counting means 14 counts an operation time of the measuring or analyzing apparatus or an operation time of every measuring or analyzing program held by the user 4 to house the obtained operation time in the user's data 10a. Incidentally, it is also possible to house therein a starting time and termination time of the operation in addition to the operation time.

The accounting means 15 calculates a fee for each user 4 based on the operation time obtained at the operation time counting means 14 to store the same in the user's data 10a. Incidentally, in the calculation of each fee, all the expenses or a part thereof required for the sale of the measuring or analyzing apparatus can be calculated such that a standard amount of the fee is calculated in advance with reference to the mode number and process contents of the measurement or analysis and/or estimated using cumulative time, and the standard amount is multiplied by the kinds of the users, the kinds and numbers of the measuring or analyzing programs (measuring or analyzing mode), process contents and operation time. In addition thereto, the fee may also be calculated by multiplying the standard amount by a coefficient according to the contents agreed between each user 4 and the seller.

The fault diagnosing means 16, at the request of a fault diagnosis from the user 4, reads a fault diagnosing program suitable for the apparatus and fault contents to be diagnosed from the fault diagnosing programs a, fault diagnosing program b, fault diagnosing program c, . . . , and data for inspection are transmitted or inspection data are received from or by the user's request responding means 11 through the internet 5 to thereby diagnose.

Also, the server 3 is connected to a business or sales division 20, operation division 21 having a measuring or analyzing apparatus, development & technical division 22 or service division 23 on the side of the seller 2 through a local area network (hereinafter referred to LAN), and the respective divisions obtain the necessary data from the data base 10 in the server 3 to store therein. For example, the business division 20 reads the operation time and fees from the user's data 10a through LAN to prepare a bill for each user 4. The operation division 21 and development & technical division 22 send the measuring or analyzing programs, which have been developed or upgraded, to the measuring or analyzing program data 10b through LAN to thereby add or renew the programs. Also, when a program is developed or upgraded, an analysis based on the diagnosis results of the fault diagnosing means 16 can be used.

The service division 23 may, if necessary, adjust the apparatus held by the user 4 based on the diagnosis results of the fault diagnosing means 16.

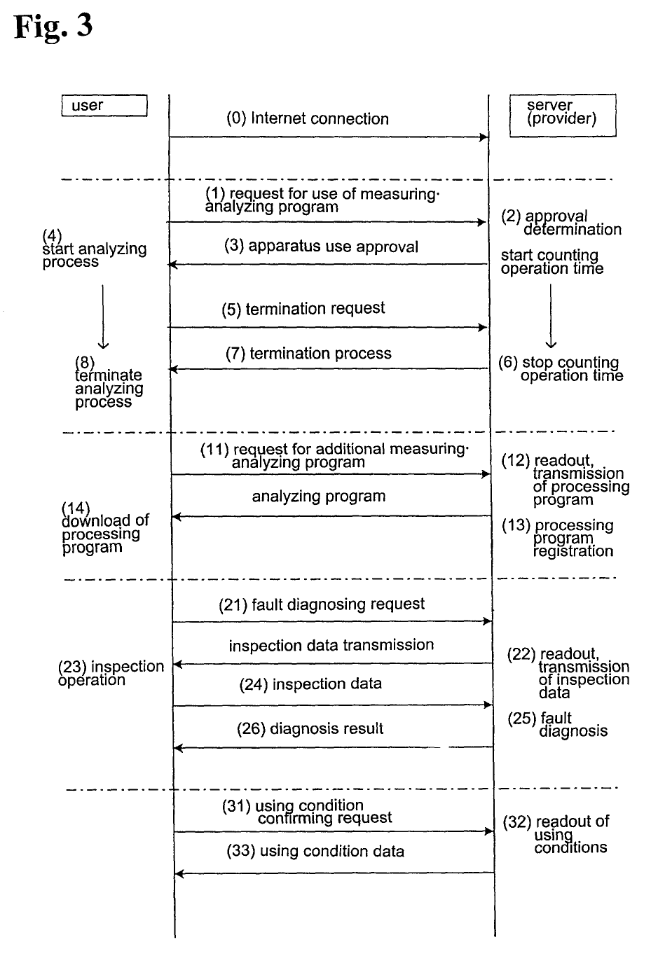

Next, tasks between the terminal on the user's side and the server on the seller's side are explained with reference to FIG. 3. The terminal on the user's side is connected to the server on the seller's side through the internet ((0) in the drawing). At this time, the terminal on the user's side is connected to the measuring or analyzing apparatus held by the user to obtain a using approval and using condition of the measuring or analyzing apparatus.

Hereunder, respective task processes, such as the measuring and analyzing process, download process of a program to the user, fault inspection process and condition confirmation process, by the measuring or analyzing apparatus are explained.

The measuring or analyzing process by the measuring or analyzing apparatus is carried out such that when the user sends a request for use of the measuring or analyzing apparatus to the server ((1) in the drawing), the server confirms a use approval of a requested apparatus and program, and when the use approval is confirmed, count of the operation time starts ((2) in the drawing) to approve the use of the apparatus and program held by the user through the internet. The use approval is executed by transmitting an approval code to the apparatus on the user's side ((3) in the drawing).

The user starts the measuring or analyzing process ((4) in the drawing), and when terminated, the user transmits a termination request to the server through the internet ((5) in the drawing). The server stops counting of the operation time upon receipt of the termination request ((6) in the drawing), and executes the termination process for terminating the measuring or analyzing apparatus of the user through the internet ((7) in the drawing) to subject the measuring or analyzing apparatus to the termination process ((8) in the drawing).

The process for downloading a program to the user is carried out such that when the user requests an addition or an upgrade of the program with respect to the server ((11) in the drawing), the server reads the requested program from the data base ((12) in the drawing), and at the same time, registers it as the program to be used ((13) in the drawing). The user downloads the program transmitted through the internet to thereby add the program or upgrade ((14) in the drawing).

The fault diagnosing process is carried out such that when the user requests the server to make a fault diagnosis ((21) in the drawing), the server reads a fault diagnosing program and data for inspection suitable for the fault contents from the data base and transmits the data for inspection ((22) in the drawing). The user applies the transmitted data for inspection to the apparatus to execute the inspection operation ((23) in the drawing), and the obtained inspection data are transmitted to the server through the internet ((24) in the drawing). The server diagnoses the fault using the inspection data according to the fault diagnosis program ((25) in the drawing), and the diagnosed results are transmitted to the user ((26) in the drawing).

The condition confirming process is carried out such that when the user requests confirmation of the using conditions, such as the use approval contents, operation time and charged amount, with respect to the server ((31) in the drawing), the server reads data about the requested using conditions from the data base ((32) in the drawing), and transmits them to the user ((33) in the drawing).

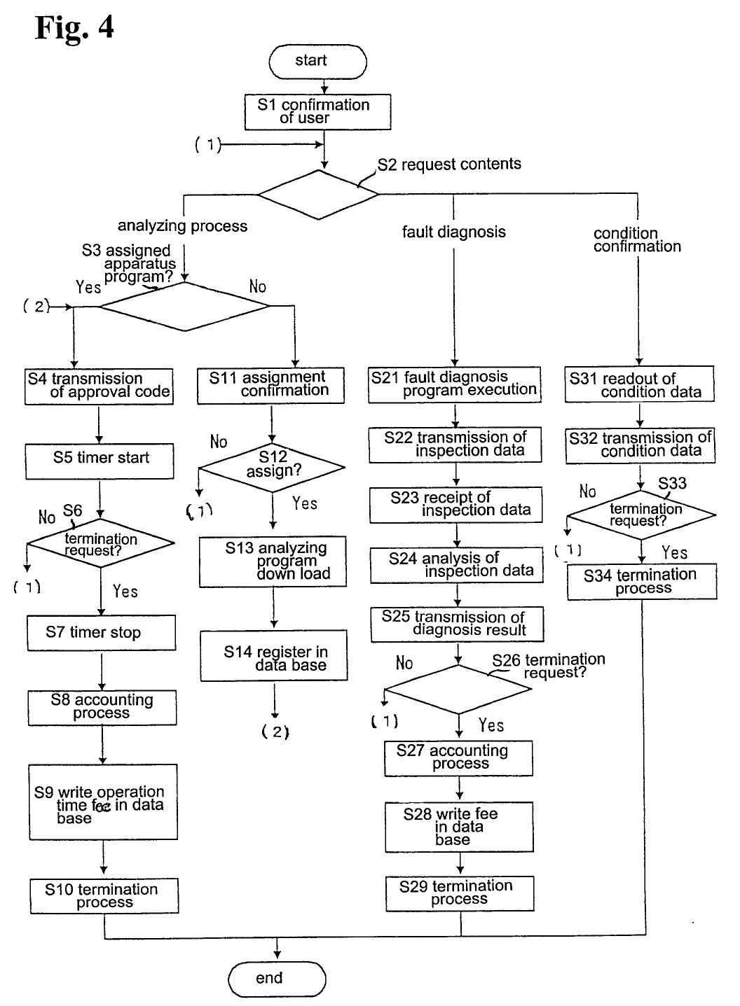

Next, the process executed by the server is explained with reference to the flow chart shown in FIG. 4.

In the server, the user's request responding means 11 confirms the request from the user (Step S1), and the request content determining means 12 determines the request contents (Step S2).

In case the request contents relate to the measuring or analyzing process, the following Steps S3-S14 are executed, and a fee corresponding to the use of the measuring or analyzing apparatus prosecuted on the side of the user is calculated.

The use approval determining means 13 determines whether the apparatus or process program (measuring program or analyzing program) requested by the user is approved in advance with reference to the use apparatus code and assigned program name in the data base (Step S3). In case the apparatus or the process program is approved, an approval code for approving the use of the apparatus or process program requested by the user is transmitted to the user (Step S4), and a timer is set to start counting an operation time (Step S5).

When the user requests termination of the process (measuring process or analyzing process) (Step S6), the timer is stopped to stop counting of the operation time (Step S7). Incidentally, until the user transmits a request for termination of the process (measuring process or analyzing process), the process returns to Step S2 to continue processing (Step S6).

Accounting means 15 calculates a fee according to the obtained operation time as well as the used program and process contents. For example, the fee can be calculated by dividing expenses required for purchasing the apparatus with usable program number to obtain a standard price per program unit, and multiplying the standard price per program unit by the approved program number (Step S8).

The operation time and fee are written in the data base (Step S9), and the termination process is executed. The user may have a password, and the measuring or analyzing apparatus may be terminated by the password when the termination process is executed. When the measuring or analyzing apparatus is used again, the assigned password can be decoded by an approval code, so that only when the server approves its use, the measuring or analyzing apparatus or the process program can be used. The password for approving the use may be assigned to both of the measuring or analyzing apparatus and the process program, or only the process program according to an agreement between the user and the seller.

Also, the password assigned at the time of termination of its use can be encrypted by an open key, and a password assigned at the time of start of its use can be encrypted by a secret key (Step S10).

Also, in Step S3, when the requested process contents are not the assigned program, an assigned program is identified between the user and the seller (Step S11), and the program to be used is assigned to the server. Incidentally, in case the program is not assigned, the process is returned to Step S2 to continue the processing (Step S12).

In case the program is assigned, the server reads the process program (the measuring or analyzing program) from the data base and downloads the program to the user (Step S13), and at the same time, registers the assignment of the program to the data base (Step S14).

In case the requested contents relate to a fault diagnosis, the following Steps S21 to S29 are carried out, and a fee required for the fault diagnosis is calculated.

The fault diagnosing means 16 reads a necessary fault diagnosing program from the fault diagnosing program data 10c to execute the same (Step S21), and transmits data for inspection to the apparatus on the side of the user (Step S22). The server receives inspection data obtained from the apparatus on the side of the user through an inspection operation (Step S23), analyzes the inspection data (Step S24), and transmits the diagnosis results to the user (Step S25).

When the user sends a request for termination of the process (measuring or analyzing process) (Step S26), the server executes the accounting process for calculating the fee required for the fault diagnosis (Step S27), writes the calculated fee in the data base (Step S28), and then executes the same termination process as in Step S10 (Step S29).

Incidentally, until the termination request of the process (measuring or analyzing process) is sent from the user, the process is returned to Step S2 to continue the processing (Step S26).

In case the request contents relate to a condition confirmation diagnosis, the following Steps S31-S34 are carried out. The condition contents to be confirmed include, for example, an operation time, fee, assigned program contents, fees required for other usable program contents and their use.

The user's request responding means 11 reads the requested condition contents from the data base (Step S31), and transmits the read-out condition contents to the user (Step S32).

When a request for termination of the process (measuring or analyzing process) from the user is received (Step S33), the same termination process as in Steps S10 and S29 is carried out (Step S34). Incidentally, until the user transmits the request for termination of the process (measuring or analyzing process), the process returns to Step 2 to continue the processing (Step S33).

Incidentally, while the above embodiment is structured such that the operation time of the apparatus can be obtained by controlling the start and stop of the apparatus installed on the side of the user through the use approval determining means and approval code, the operation time of the apparatus may be obtained by keeping connection between the user side and the server side through the internet during the operation of the apparatus.

According to the present embodiment of the invention, there are such advantages that, for example, the user can obtain an ownership of the apparatus by only paying a cost required for manufacturing the apparatus at the time of its purchase; and there is no necessity of physically moving the apparatus whenever the apparatus is used.

According to the present invention, there are also such advantages that the user can only pay expenses according to the using conditions, such as the using time, in addition to the initial cost at the time of its purchase and maintenance fees required after its introduction, so that a user who does not use the apparatus frequently need not pay extra expenses, while a user who uses the apparatus frequently may only pay reasonable expenses according to the using conditions.

Further, according to the present invention, the seller can obtain the using conditions of the process programs used by the user, and the requests and fault diagnosing results from the user may be used to improve the process programs.

As described above, according to the sales method and sales system of the measuring or analyzing apparatus of the present invention, the measuring or analyzing apparatus is transferred to the user before its payment is completed, and the user can start using the apparatus with a small amount of money with respect to the whole cost.

While the invention has been explained with reference to the specific embodiments of the invention, the explanation is illustrative and the invention is limited only by the appended claims.

What is claimed is:

1. A method of conducting a business with a treating apparatus, comprising:
installing the treating apparatus to a user;
connecting the treating apparatus at the user to a server on a seller's side through a communication line;
using the treating apparatus through the communication line; and
charging a fee of the treating apparatus based on a measured rate system according to a using condition of the treating apparatus.

2. A method of conducting a business with a treating apparatus according to claim 1, further comprising downloading a program to be used for the apparatus from the server through the communication line.

3. A method of conducting a business with a treating apparatus according to claim 1, further comprising diagnosing a fault of the treating apparatus through the communication line.

4. A method of conducting a business with a treating apparatus according to claim 3, further comprising charging a fee for diagnosing the fault of the treating apparatus through the communication line.

5. A method of conducting a business with a treating apparatus according to claim 1, wherein said treating apparatus is at least one of a measuring apparatus and an analyzing apparatus, and the fee is one of a whole cost and a part thereof.

6. A method of conducting a business with a treating apparatus according to claim 1, wherein when the user uses the treating apparatus, the treating apparatus is connected to the server through the communication line, and is used upon permission from the server.

7. A method of conducting a business with a treating apparatus according to claim 6, wherein said using condition includes one of actuating the treating apparatus, downloading a program of the treating apparatus, and diagnosing a fault of the treating apparatus in case of a fault condition.

8. A method of conducting a business with a treating apparatus according to claim 7, further comprising connecting a seller to the server through the communication line to proving the fee of the treating apparatus at the user to the seller.

9. A method of conducting a business with a treating apparatus according to claim 8, wherein said seller provides an update program and a new program for the treating apparatus to the server to allow the user to access to information of the update and new programs.

10. A system of conducting a business with a treating apparatus, comprising:
a terminal connected to the treating apparatus on a user's side, said terminal connecting the treating apparatus to a communication line; and
accounting means installed at a server on a seller's side and connected to the communication line, said accounting means calculating a fee according to a using condition of the treating apparatus through the communication line and charging the fee to the user.

11. A system of conducting a business with a treating apparatus according to claim 10, wherein said accounting means calculates an amount to be charged, of the treating apparatus based on a processing content and an operation time of the treating apparatus through the communication line.

12. A system of conducting a business with a treating apparatus according to claim 10, further comprising means for storing information used by the treating apparatus at the server, said storing means including a program to be used for the apparatus and a fault-diagnosing program.

13. A system of conducting a business with a treating apparatus according to claim 10, wherein said treating apparatus is at least one of a measuring apparatus and an analyzing apparatus, and the fee is one of a whole cost and a part thereof.

14. A system of conducting a business with a treating apparatus according to claim 10, wherein said using condition includes one of actuating the treating apparatus, downloading a program of the treating apparatus, and diagnosing a fault of the treating apparatus in case of a fault condition.

15. A system of conducting a business with a treating apparatus according to claim 14, further comprising an update program and a new program for the treating apparatus provided from a seller to the server to allow the user to access to information of the update and new programs.
